(19) United States
(12) Patent Application Publication
(10) Pub. No.: US 2015/0108716 A1
(43) Pub. Date: Apr. 23, 2015

(54) MACHINE FOR PROCESSING ELEMENTS IN SHEET FORM, INCLUDING A FEED BOARD FITTED WITH CONVEYING MEANS

(71) Applicant: BOBST MEX SA, Mex (CH)

(72) Inventor: Michel Rod, Semsales (CH)

(21) Appl. No.: 14/398,331

(22) PCT Filed: Apr. 24, 2013
(86) PCT No.: PCT/EP2013/001226

§ 371 Date: Oct. 31, 2014

(30) Foreign Application Priority Data
May 3, 2012 (EP) 12003239.6

(51) Int. Cl. B31B 1/04; B65H 11/00; B65H 5/02

(52) U.S. Cl. CPC B31B 1/04; B65H 5/021; B65H 11/002; B31B 2201/0247; B31B 2201/94
USPC 271/275

(57) ABSTRACT

A machine for processing plate elements is fitted with a station for processing the elements (4), and a feed table (3), positioned upstream of the station (4) and provided with a conveyor and a frame (13); the conveyor includes at least a removable conveyor cassette (23, 24) with an endless conveyor belt (14, 16) in the cassette, and the cassette is inserted , attached to and able to be removed (O) from the frame (13).

The present invention concerns a machine for processing board elements, comprising a feed board provided with means for conveying the board elements.

A processing machine, for example a flat-bed cutter type forwarding machine, is notably used in the printing and packaging industry, for example for making up cardboard boxes from board elements, such as sheets.

In the machine, the board elements are taken up by a conveyor, taking the form of clamping bars mounted at regular intervals on a row of endless chains that enables the board elements to be brought to the various successive processing stations of the machine. The row of chains moves and stops periodically with a timed progress so that during each movement all the clamping bars that have taken up board elements are moved from an upstream station to the next adjacent downstream station.

In the cutting machine example, the stations are successively a station for cutting board elements with a cutting form, a station for ejecting waste with an ejection form, and a station for receiving a stack of the cut board elements.

In an insertion station at an entry of the machine the board elements are taken from the top of a stack placed on the upstream side of the machine. The board elements are disposed in the form of a layer and conveyed in the upstream to downstream direction by a feed board. To form the layer, the board element on the top of the stack is taken up from behind and then pushed forward by an inserter, the front part of the board element that has been taken up sliding under the preceding board element already taken up and then released.

The board elements of the layer are then each precisely positioned laterally and longitudinally before being taken up by the clamping bars. Positioning is effected at one of the downstream ends of the feed board. Positioning is carried out either with the board elements stopped by front and lateral abutments against which the edges of the board element bear or using a more sophisticated system that does not necessitate stopping of the board elements.

### PRIOR ART

The feed board is provided with conveyor means for conveying the board elements in the upstream to downstream direction. The feed board has an inclined top plane, which may be a metal plate or a wooden board, for example, mounted on a frame. One or more passages of rectangular shape are provided in the top plane.

A plane upper face of an endless conveyor belt is engaged in the passage and is substantially flush with the top plane. When a plurality of belts is present, they are disposed side-by-side over the width of the top plane and spaced by portions of the plane having a rectangular shape.

A processing machine can achieve processing rates from 8000 to 12000 board elements per hour. Because of the abrasive properties of the material constituting the board elements, this rapid movement of the board elements over the feed board generates high wear of the belt(s).

A worn belt loses its flexibility properties, stretches, or even breaks. The consequence of using a worn belt is that the board elements will no longer be placed precisely and regularly in the layer. This causes modifications of the positioning of the board elements conveyed by the belts at the exit from the feed board. These positioning modifications lead to incorrect positioning where the clamping bars take up the board elements, incorrect processing of the board elements, or even the board elements jamming in the machine. Rollers or wheels retaining the belt(s) may also become worn or even break.

The conveyor belt and its rollers therefore constitute wear parts that must be changed regularly. A first technique consists in dismantling the feed board and the components of the top plane, removing the defective belt, fitting the new belt and then reassembling everything, carrying out any necessary adjustments. A second and faster technique consists in cutting the worn belt while in the machine. The new belt is fitted by directly butt-jointing its respective free ends by bonding or by welding while in the machine. The new belt must be tensioned.

All these maintenance operations take time. These operations are sources of error, for example where the flatness at the level of the joint in the butt-jointed new belt is concerned. These operations prove somewhat impractical, increase the machine downtime, and are therefore more tiring for the operator. During these downtimes the machine is no longer in production.

### SUMMARY OF THE INVENTION

A main objective of the present invention consists in producing a machine for processing board elements equipped with a feed board. A second objective is to simplify, facilitate and accelerate changing the conveyor means. A third objective is to make feed board maintenance operations more ergonomic. A further objective is to solve the technical problems referred to in connection with the prior art.

A machine in accordance with the invention for processing board elements is equipped with:
a station for processing the elements, and
a feed board, which is positioned on the upstream side of the station for processing the elements and provided with conveyor means and a frame.

According to a main aspect of the present invention, the machine for processing board elements is characterized in that the conveyor means for the board elements take the form of at least one removable conveyor cassette with endless conveyor belt(s) inserted in, fixed to and adapted to be removed from the frame of the feed board.

By way of non-exhaustive example, the board element is defined as being in a board or sheet material, such as paper, flat cardboard, corrugated cardboard, laminated corrugated cardboard, flexible plastic (for example polyethylene (PE), polyethylene terephthalate (PET), bi-oriented polypropylene (BOPP) or other polymers) or other materials.

The board element is processed in the processing machine. The processing may be cutting, the processing machine being, by way of non-exhaustive example, a flat-bed cutting machine. The processing may be applied to the surface of the element, to apply graphic signs to it and/or to impart an aesthetic appearance to it. The processing may be scoring, embossing, forming, hot foil stamping, affixing labels or holograms, etc. The processed element could include a layer of varnish covering all or part of the surface.

The upstream and downstream directions are defined with reference to the direction of longitudinal movement of the element through the processing machine from the insertion station.

In other words, the operator will replace a cassette with worn belt(s) with a new cassette with new belt(s). Maintenance is easier with a cassette that is easily dismantled in an appropriate shop away from the machine where a new endless belt, already in loop form and of better quality than a butt-jointed belt, can be placed in the cassette immediately as a replacement for the worn belt. The operator will also be able to use a replacement conveyor cassette that is ready for use already and very quickly substitute the replacement cassette for the cassette with worn belt(s) with limited machine downtime.

According to another aspect of the invention a removable conveyor cassette for a feed board positioned on the upstream side of a station for processing board elements in a machine for processing board elements includes a structure, at least two upstream and downstream rollers carried by the structure, at least one endless conveyor belt tensioned by the two upstream and downstream rollers, defining a plane upper face, conveying at least one element over the plane upper face, and driven by a driving shaft of the board, the conveyor cassette being adapted to be inserted in, fixed to and removed from a frame at the level of the feed board.

According to a further aspect of the invention a machine for processing board elements of the flat-bed cutter forwarding machine type is characterized in that it includes at least one removable cassette inserted in a feed board and having one or more of the technical features described below and claimed.

### BRIEF DESCRIPTION OF THE DRAWINGS

The invention will be more clearly understood and its various advantages and features will emerge more clearly from the following description of a nonlimiting embodiment given with reference to the appended diagrammatic drawings, in which:

FIG. 1 represents a perspective view of a machine for processing a board element;

FIG. 2 represents a partial perspective view of the top of a feed board;

FIG. 3 represents a partial perspective view of the bottom of the feed board equipped with a conveyor cassette according to the invention;

FIG. 4 represents a partial perspective view of the bottom of the feed board, the cassette being represented with the belt relaxed; and

FIG. 5 represents a partial perspective view of the top of the feed board with the cassette represented in an extracted position.

### DETAILED DESCRIPTION OF PREFERRED EMBODIMENTS

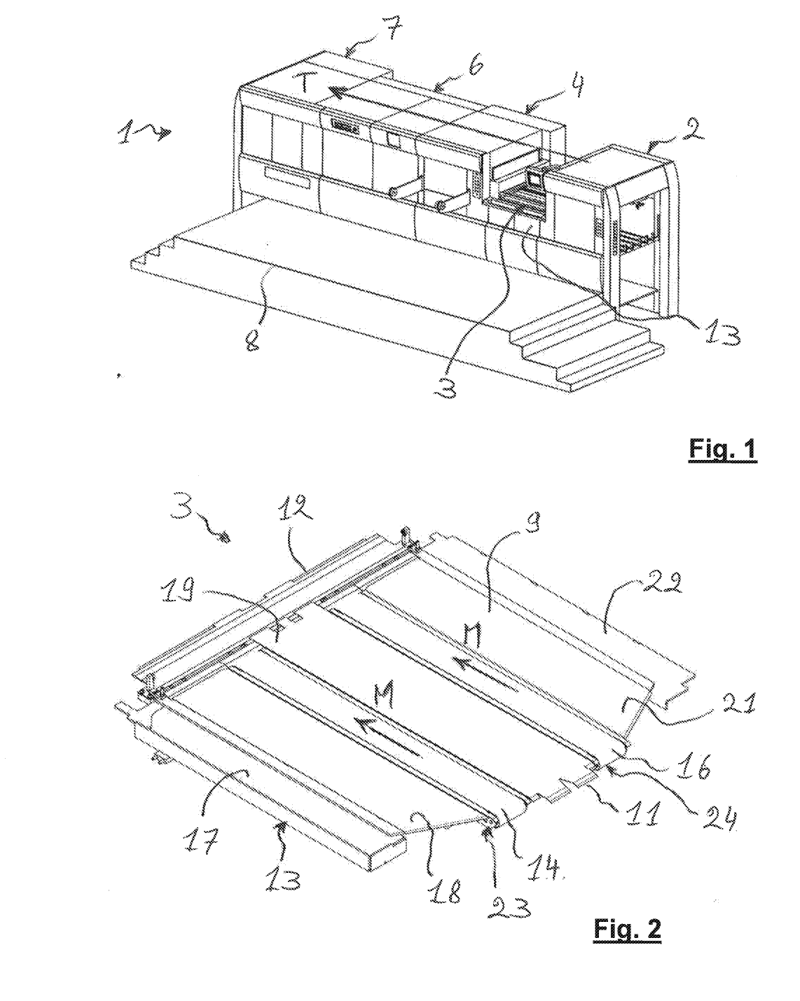

FIG. 1 shows a machine for processing a board element, here by way of example a forwarding press 1 of the flat-bed cutter type. The press 1 comprises different stations 2, 3, 4, 6 and 7 for forwarding, i.e. cutting, the board element, here for example a cardboard sheet.

The press is equipped in this order and in the upstream to downstream direction with an insertion station 2, a feed board 3, a processing station 4, a waste ejection station 6 and a reception station 7. The processing station 4 incorporates a flat-bed cutter, the board passing between a mobile lower support on which a cutting form is mounted and a fixed upper support.

Each board to be cut is taken up and conveyed in the longitudinal direction (arrow T in FIG. 1) through the press 1 from the insertion station 2 to the reception station 7. The longitudinal direction is defined with reference to the direction of movement of the board in the machine 1, along its median longitudinal axis. The front is defined with respect to the front face of the machine, on the same side as the control console 8 of the machine 1, known as the “operator side”. The rear is defined with respect to the rear face of the machine 1 on the side opposite the control console 8 of the machine, known as the “opposite the operator side”. The upper and lower directions are defined with respect to the machine 1 and the feed board 3 when operating or ready to operate (FIGS. 1, 2 and 5).

The feed board 3 has an upper area 9 with an upstream side 11 and a downstream side 12. The sheets are placed in a layer on the upstream side 11. The layer of sheets moves over the upper area 9 of the board 3. The sheets are each positioned precisely on the downstream side 12 of the board 3 by tamping abutments or by a mobile mechanism (not shown).

The feed board 3 includes a lower frame 13. The feed board 3 is provided with conveyor means with two endless drive belts 14 and 16 for conveying the layer (see FIGS. 2 to 5). The upper face of the two belts 14 and 16 is situated in the same plane as and flush with the upper area 9.

The two drive belts 14 and 16 are deployed and move longitudinally (arrow M in FIG. 2) from the upstream side 11 to the downstream side 12. The upper area 9 of the board 3 is in this case successively composed, from the front to the rear, of an anterior plate 17 of the frame 13, a first plate 18 at the front, the first belt 14 at the front, a central plate 19, the second belt 16 at the rear, a second plate 21 at the rear, and a posterior plate 22 of the frame 13.

According to the invention, the conveyor means take the form of at least one removable conveyor cassette and in the present case two conveyor cassettes 23 and 24. The first belt 14 at the front is part of the first cassette 23 at the front and the second belt 16 at the rear is part of the second cassette 24 at the rear. Each of the two cassettes 23 and 24 is an independent unit provided in this case with a single endless conveyor belt 14 and 16.

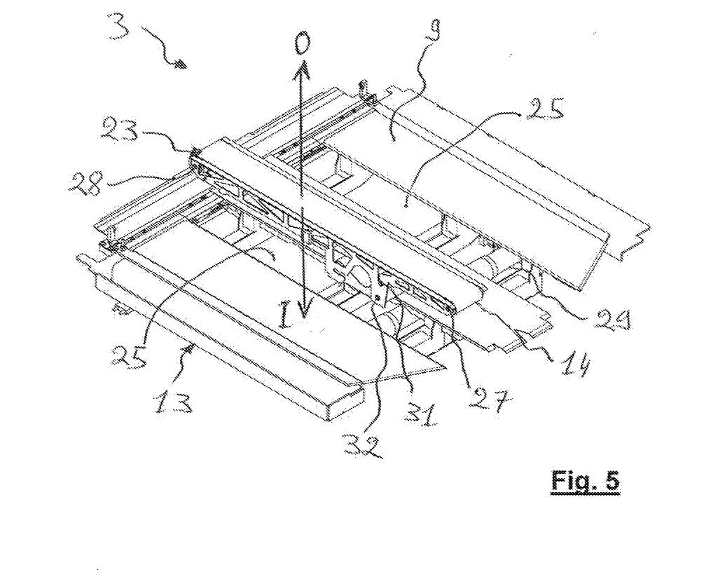

The cassette 23 or 24 is adapted to be inserted into the frame 13 in the downward direction (arrow I in FIG. 5). The cassette 23 or 24 is adapted to be fixed to the frame 13, for example by appropriate bolts. Conversely, the cassette 23 or 24 is adapted to be extracted and removed from the frame 13, and thus from the feed board 3, in the upward direction (arrow O in FIG. 5). A housing 25 for each of the cassettes 23 or 24 is provided in the frame 13, under the upper area 9.

Each cassette 23 or 24 includes a retaining structure 26. An upstream end of the structure 26 carries the axle of an upstream upper roller 27. A downstream end of the structure 26 carries the axle of a downstream upper roller 28. The endless belt 14 is tensioned between these two upstream and downstream rollers 27 and 28. The two rollers 27 and 28 and their respective upstream and downstream upper positions define the plane upper face of the belt 14 when the cassette 23 accompanied by its structure 26 is placed in the frame 13. The structure 26 is constructed with two perforated lateral plates joined together by spacers.

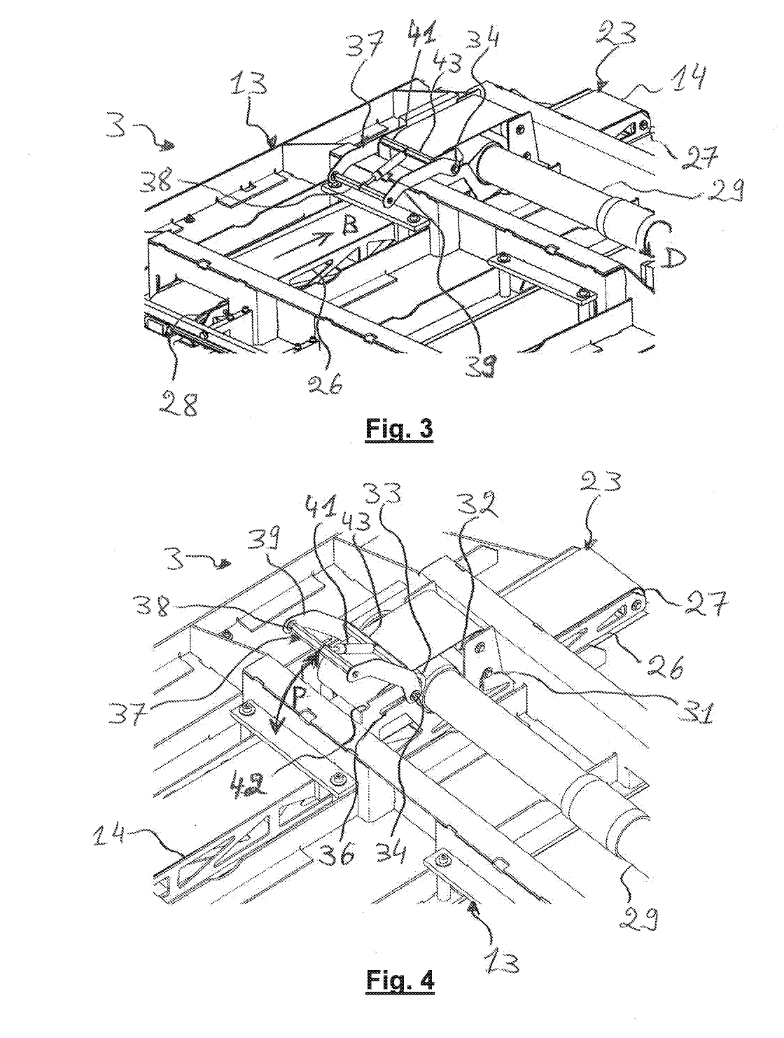

The belt 14 is an endless loop passing over and deflected by the two upstream and downstream rollers 27 and 28. The belt 14 is advanced longitudinally (arrow M), being pressed onto part of the circumference of a driving shaft 29 of the board 3 and cooperating with it by friction. The driving shaft 29 is situated under the upper area 9 of the board 3. The driving shaft 29 turns (arrow D in FIG. 3) when driven by a motor of the board 3.

To maintain the path of the belt 14, three additional idler rollers 31, 32 and 33 are provided, mounted on the structure 26 (only their respective axles can be seen clearly in FIGS. 3 to 5). Two upstream lower rollers 31 and 32 are positioned one above the other between the driving shaft 29 and the upstream roller 27. A first upstream lower roller 31 is situated at substantially the same level as the driving shaft 29. A downstream lower roller 33 is positioned between the driving shaft 29 and the downstream roller 28. A second upstream lower roller 32 is situated at substantially the same level as the downstream roller 33.

After its plane upper face, the return path of the belt 14 (arrow B in FIG. 3) runs in the downstream to upstream direction and from the downstream upper roller 28 successively around the driving shaft 29, the downstream lower roller 33, the second upstream lower roller 32 and the first upstream lower roller 31 to return to the upstream upper roller 27.

It is beneficial if the cassette 23 includes means for tensioning and relaxing the belt 14 (see FIGS. 3 and 4). To this end, the means for tensioning and relaxing the belt 14 advantageously include the downstream lower idler roller 33 which is mounted so as to be able to move in longitudinal translation.

In an upstream longitudinal position of the downstream lower roller 33 the belt 14 is relaxed. In a downstream lower downstream longitudinal position 33 the belt is tensioned. The downstream lower roller 33 preferably includes an axle 34. Each of the two ends of the axle 34 slides in the upstream or downstream direction in a longitudinal slot 36 provided in each of the two plates of the structure 26 of the cassette 23.

The means for tensioning and relaxing the belt 14 advantageously include a holding device 37 mechanically connected to the axle 34 of the downstream lower idler roller 33 and adapted to pivot relative to it (arrow P in FIG. 4). The holding device 37 takes the form of a rod 38 forming a handle mounted between two lateral flanges 39. The two flanges pivot relative to each of the ends of the axle 34.

The holding device 37 is fastened to return means 41 that bear on a fixed point 42 provided for example at the level of each of the two plates of the structure 26. The return means 38 are of cylinder type, the body of the cylinder being fixed to a spacer 43 between the two flanges 39 and the piston rod of the cylinder being fixed to the rod 38. The spacer 43 is housed in two notches forming the fixed points 42 of each of the two plates of the structure 26.

The means for tensioning and relaxing the belt 14, with the downstream lower idler roller 33, the holding device 37 and the return means 38, are preferably demountable, for example by unscrewing one flange of the holding device 37.

A method of changing the conveyor belt 14 in the feed board 3 positioned on the upstream side of the board processing station 4 for the flat-bed-type cutting machine 1 comprises the steps consisting in demounting and extracting the cassette 23 (step O); removing the belt 14; fitting a new belt 14; and inserting and fixing the cassette 23. This method comprises a supplementary step consisting in relaxing the belt 14 and then tensioning the new belt 14. This method comprises a supplementary step consisting in demounting the means for tensioning and relaxing the belt 14.

The present invention is not limited to the embodiments described and shown. Numerous modifications may be made without departing from the framework defined by the scope of the set of claims.

1. A machine for processing plate elements, the machine being fitted with:
a processing station for processing the plate elements;
a feed table, positioned upstream of the processing station, the table being provided with a conveyor and also with a frame supporting the conveyor;
the conveyor comprises at least one removable conveyor cassette including an endless conveyor belt at the cassette, the cassette being inserted in (I), detachably attached to and configured to be removed from the frame.

2. A removable conveyor cassette for a feed table of a processing machine;
a station for processing plate elements in the processing machine;
the conveyor cassette being positioned upstream of the processing station;
the cassette comprising:
a structure;
at least an upstream roller and a downstream roller carried by the structure arranged in a path of feeding claims over the table;
at least one endless conveyor belt between and tensioned by the two rollers, the belt defining a plane upper face, and the belt and the rollers being configured for conveying at least one of the plate elements on the face, and;
a driving shaft of the table engaging the belt for conveying the at least one plate element;
the cassette and the structure of the cassette being configured for the cassette to be inserted in, attached to and removed from the frame so as to be at the table.

3. A cassette according to claim 2, further comprising means for tensioning and relaxing the belt between the rollers.

4. A cassette according to claim 3, wherein the means for tensioning and relaxing the belt comprise a return roller which is mobile in translation between a tensioning position in which the belt is tensioned and a relaxing position in which the belt is relaxed.

5. A cassette according to claim 4, further comprising:
the structure of the cassette includes a slot; the return roller has a rotation axle configured for sliding in the slot provided in the structure;
the slot is oriented for causing adjustment of the tension of the belt as the return roller and the axle are moved along the slot.

6. Cassette according to claim 5, further comprising the means for tensioning and relaxing the belt comprise a holding device pivotable relative to the rotation axle of the return roller and thereby movable between a position holding the axle against moving and a position permitting movement of the axle in the slot.

7. Cassette according to claim 6, wherein the holding device is joined to biasing means bearing on a fixed point of the structure.

8. A cassette according to claim 3, wherein the means for tensioning and relaxing the belt are dismountable.

9. A machine for processing plate elements, by converting the elements by cutting using a platen;
the machine comprises a feed table and at least one cassette according to claim 2 inserted in the feed table.

10. A machine according to claim 9, wherein the table comprises a driving shaft configured and located for driving by friction at least one belt of at least one cassette in the feed table.
